(19) United States
(12) Patent Application Publication
(10) Pub. No.: US 2009/0109967 A1
(43) Pub. Date: Apr. 30, 2009

(54) METHOD AND SYSTEM FOR REMOTELY CONFIGURING AN ETHERNET SWITCH USING ETHERNET PACKETS

(76) Inventors: Anirban Banerjee, Bangladore (IN); Vamsi Tatapudi, Milpitas, CA (US); Sarath Kumar Immadisetty, Bangladore (IN)

Correspondence Address: MCANDREWS HELD & MALLOY, LTD, 500 WEST MADISON STREET, SUITE 3400, CHICAGO, IL, 60661, US

(21) Appl. No.: 11/931,462

(22) Filed: Oct. 31, 2007

(51) Int. Cl. H04L 12/56

(52) U.S. Cl. 370/386

(57) ABSTRACT

The disclosed systems and methods relate to remote configuration of an Ethernet Switch. Aspects of the present invention may reduce the time and cost associated with configuring and maintaining one or more Ethernet Switches in a network.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

An Ethernet Switch is typically configured at the point of manufacturing or when it is put into service. The configuration may be performed within the Ethernet Switch by an on-board processor.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for remotely configuring an Ethernet Switch as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating an exemplary method for remotely configuring an Ethernet Switch in accordance with a representative embodiment of the present invention;

FIG. 2 is an illustration of an exemplary system for remotely configuring an Ethernet Switch in accordance with a representative embodiment of the present invention;

FIG. 3 is an illustration of a remote programmable input output operation for configuring an Ethernet Switch in accordance with a representative embodiment of the present invention;

FIG. 4A is an illustration of a first exemplary remote packet processing operation for configuring an Ethernet Switch in accordance with a representative embodiment of the present invention;

FIG. 4B is an illustration of a second exemplary remote packet processing operation for configuring an Ethernet Switch in accordance with a representative embodiment of the present invention;

FIG. 4C is an illustration of a third exemplary remote packet processing operation for configuring an Ethernet Switch in accordance with a representative embodiment of the present invention;

FIG. 4D is an illustration of a fourth exemplary remote packet processing operation for configuring an Ethernet Switch in accordance with a representative embodiment of the present invention;

FIG. 4E is an illustration of a fifth exemplary remote packet processing operation for configuring an Ethernet Switch in accordance with a representative embodiment of the present invention; and

FIG. 4F is an illustration of a sixth exemplary remote packet processing operation for configuring an Ethernet Switch in accordance with a representative embodiment of the present invention.

### DETAILED DESCRIPTION OF THE INVENTION

Aspects of the present invention relate to the configuration of an Ethernet Switch by data packets or Ethernet frames which originate from a processor on the same network. The processor may be a host processor, a remote CPU, or another Ethernet Switch. Although the following description may refer to a particular embodiment of an Ethernet Switch, many other embodiments may also use these systems and methods. Aspects of the present invention may minimize operational cost by enabling a single processor to remotely set up and manage one or more Ethernet Switches.

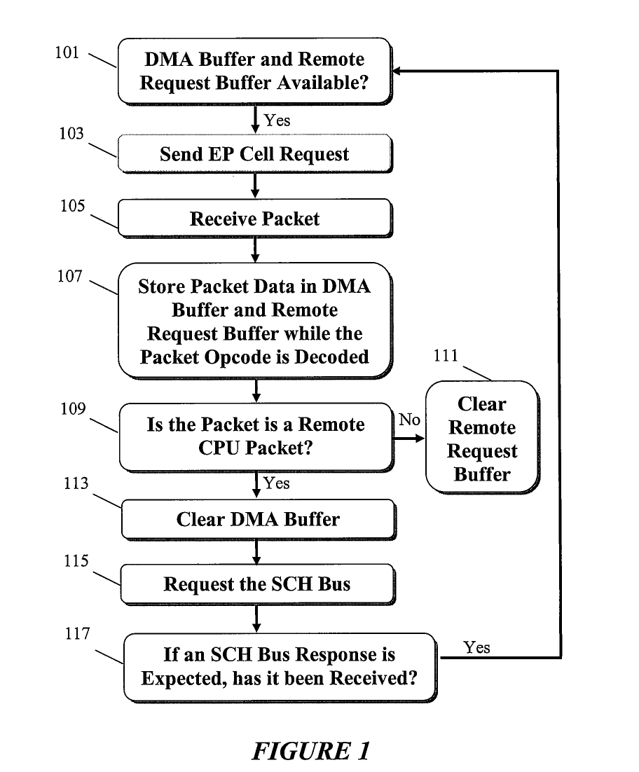

FIG. 1 is a flowchart illustrating an exemplary method for remotely configuring an Ethernet Switch in accordance with a representative embodiment of the present invention. The availability of a DMA Buffer and a Remote Request Buffer are determined at 101. If the buffers are available data packets may be received.

The Ethernet Switch may receive data packets that are requested externally, or alternatively, an Ethernet Packet (EP) Cell Request packet may be sent by the Ethernet Switch at 103.

When a packet is received at 105, the packet type is unknown by the Ethernet Switch. While the packet opcode is decoded, the packet data may be stored in the DMA Buffer and the Remote Request Buffer at 107. If the packet is determined not to be a remote processor packet (e.g. remote CPU packet) at 109, the Remote Request Buffer may be cleared at 111. If the packet is determined to be a remote CPU packet at 109, the DMA Buffer may be cleared at 113.

A remote CPU packet may request a Sideband Channel (SCH) Bus at 115. For example, a Remote Programmable I/O (RPIO) operation may involve programming a CPU Management Interface Controller (CMIC) register based on the data stored in the Remote Request Buffer and setting a START bit. The CMIC may then generate the SCH Bus command on the correct SCH ring.

The Remote CPU packet may contain a bit that specifies whether an SCH Bus response (e.g. SCH ACK) is expected. If an SCH Bus response is expected, the reception of such response may be verified at 117. The SCH ACK message may be read via the PCI once the DONE bit is set by CMIC.

A TxDMA operation, if in progress, may be interrupted at a packet boundary in order to send an SCH ACK. EP cell requests may resume at 101 once the SCH ACK has been sent, for example, on the Ingress Pipe.

An MMU backpressure signal may throttle remote packets at the packet boundary. A packet whose SOP cell has gone out on the IP Bus may continue to be sent until its EOP. At most two SEOP packets may go out the TxDMA after the assertion of the backpressure signal. Descriptor reads may be inhibited when remote packets are pending in the RxDMA Buffers or if a reply is ready in the RPIO message buffer.

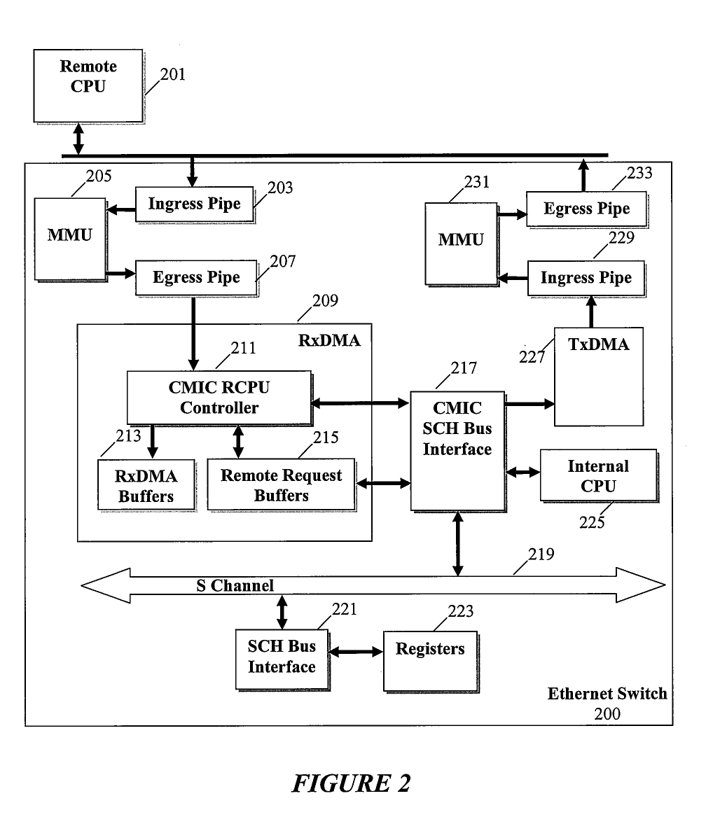

FIG. 2 is an illustration of an exemplary system for remotely configuring an Ethernet Switch in accordance with a representative embodiment of the present invention. Remote configuration operations can be accomplished by data packets coming from a remote CPU (201).

The remote CPU (201) may send a Remote Programmable Input and Output (RPIO) packet to configure one or more registers (223) or elements of a lookup table on an Ethernet Switch (200). The RPIO packet may comprise one or more CPU Management Interface Controller (CMIC) registers that include the SCH message. The RPIO packet may be sent on a Peripheral Component Interconnect (PCI) Bus.

The remote CPU (201) may also send a Remote Packet Processing (RPKT) packet. The RPKT packet may enable the remote addition or removal of data in the Ethernet Switch (200). The RPKT packet may also command a loopback of data. Exemplary loopback operations include looping back a packet: 1) with a programmable module header at a higher data rate; 2) with an L2 header added; and 3) with an L2 header removed.

These remote CPU packets will be injected into the Ingress Pipe (203) and will travel through the MMU (205) and the Egress Pipe (207) before being received and decoded by the CMIC RCPU Controller (211) in the RxDMA (209).

An RPIO or RPKT packet may be received by a DMA interface and decoded in the Ethernet Switch as an SCH operation. The RxDMA (209) comprises a CMIC RCPU Controller (211), an RxDMA Buffer and a Remote Request Buffer (215). The CMIC RCPU Controller (211) may decode the operation code (i.e. opcode) of the received data packet and match MAC addresses and VLAN IDs.

While the opcode is decoded, the packet data may be written to both the DMA Buffer (213) and the Remote Request Buffer (215). An exemplary buffer size may be 32×32-byte.

A received data packet may be an SCHAN_PKT, FROMCPU packet or TOCPU packet. Data packets coming from the Egress Pipe (207) may be categorized as: 1) those that need to go directly from the EP interface to the IP interface with or without modifications by the CMIC RCPU Controller (211) in the RxDMA (209), this includes the TOCPU, FROMCPU and SCHAN_BUSY packets; 2) those that need to be generated in CMIC, such as SCHAN_REPLY packets; or 3) packets that are not remote packets and are not to be classed as TOCPU packets.

If the packet is found to be of RPIO or RPKT type the DMA Buffer (213) may be cleared or a DMA Buffer write address may be reset to 0 and the write enable held low until the end-of-packet (EOP) cell is received. Conversely, if the packet is found to be a regular DMA packet, the Remote Request Buffer (215) may be cleared. For an RPKT, if the MAC/VLAN IDs do not match, the Remote Request Buffer (215) will be cleared as well, and no operation will take place.

Until a granting message is received, no more EP cell requests may be sent. If an earlier remote PIO command is still pending, an SCHAN_PKT is marked as an SCHAN_BUSY packet.

The CMIC on the Ethernet Switch may then generate the S-Channel command on the correct S-Channel ring. When the complete RPIO or RPKT packet has been received, a request may be sent to a CMIC SCH bus interface (217) in the Ethernet Switch. The request may indicate whether an SCHAN_REPLY is required. A start signal for remote PIO operation is generated by the CMIC SCH bus interface (217). The packet data may be transported in the S-Channel (219) as an SBus command.

The SBus command may operate to change a register (223) that may be communicatively coupled the an SCH bus interface (221). The SBus command may also read one or more registers (223) (e.g. elements in a lookup table) within the Ethernet Switch. The data in the registers may be sent back to the remote processor (201) as another RPIO packet. These results may be returned in the SCH ACK message. The data may be placed on a CMIC register and a DONE bit may then be set.

If an SCH ACK is required, an SCH ACK message, sent as a result of the SBus command, may be encapsulated with a predetermined Ethernet header. The SCH ACK message may be sent out by a TxDMA (227), through the Ingress Pipe (229), MMU (231), and Egress Pipe (233). A transmit operation on the Ethernet Switch may be interrupted at the packet boundary to send an SCH ACK. The remote processor may also receive the SCH ACK message over a PCI Bus.

The RPIO or RPKT packet may comprise a bit that resumes Ethernet packet cell requests once the SCH ACK has been sent out. An Ethernet packet cell request may be sent when the DMA and Remote Request Buffers contain at least one free buffer.

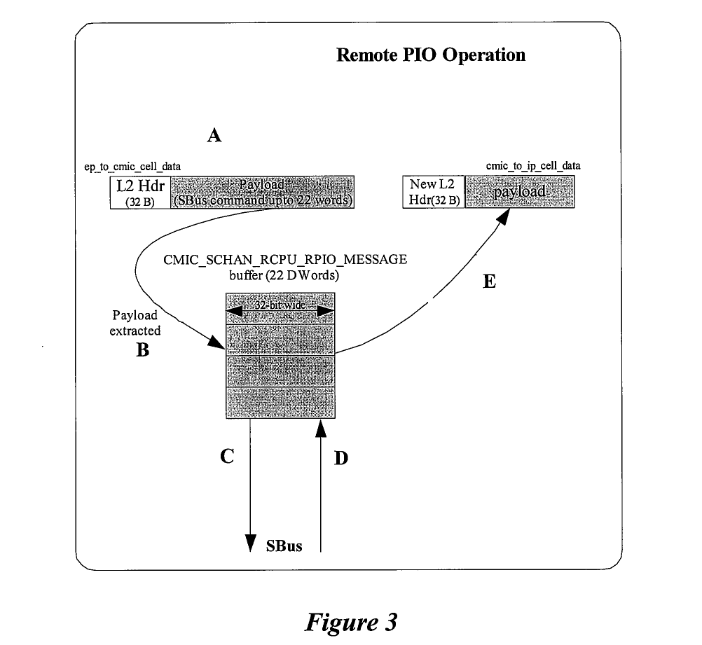

FIG. 3 is an illustration of a remote programmable input output operation for configuring an Ethernet Switch in accordance with a representative embodiment of the present invention.

At A, an SCH packet is recognized by a parser and no Remote PIO is pending. At B, the payload of the SCH packet is extracted and stored in a Remote Request Buffer. At C, there may be arbitration among Stats, Slam, and Table DMAs. A software PIO routine may decide when the RPIO data goes out as an SBus command. At D, the SCH ACK data may overwrite the command in the Remote Request Buffer. However, a time-out may supersede the overwriting. If the remote packet has a REPLY flag set, the SCH ACK data may be formed into a packet with a new L2 header and sent on the Ingress Pipe at E.

The L2 Header information from the received packet has to be stored for decoding purposes. If the packet is found to be RPIO, the first sub-cell may be overwritten with this information (from the L2 Header of the incoming packet) just before the SCH ACK returns.

Remote Packet Processing (RPKT) operations are similar to RPIO operations, except that 0, 32 or 64-byte additions may need to be made to the header of a RPKT packet by the CMIC. A user may program this header in the CMIC registers. The first 32 bytes of the RPKT packet may need to be removed from the stream.

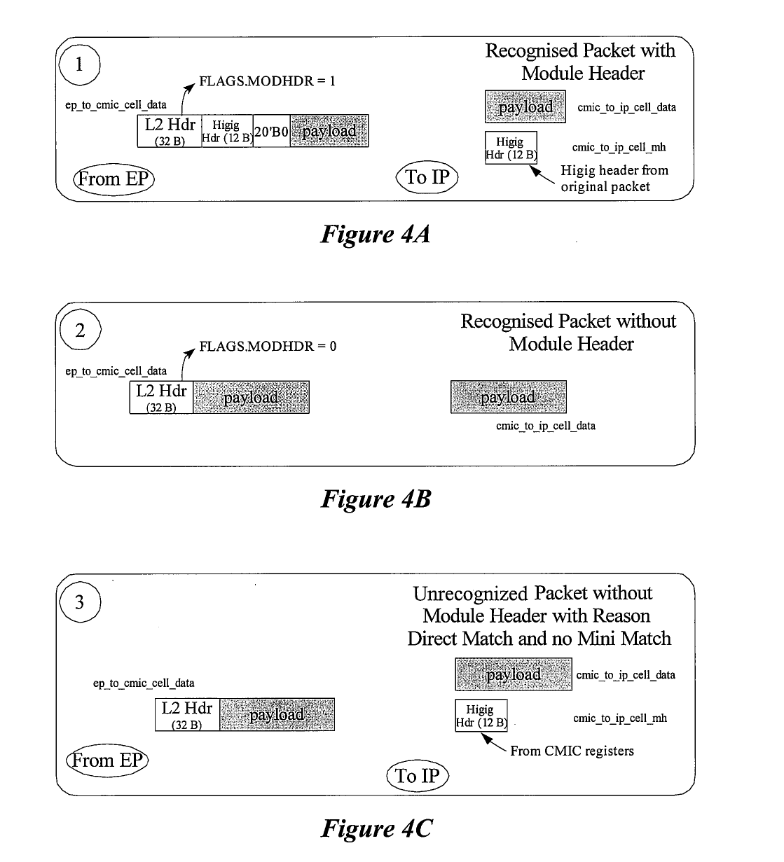

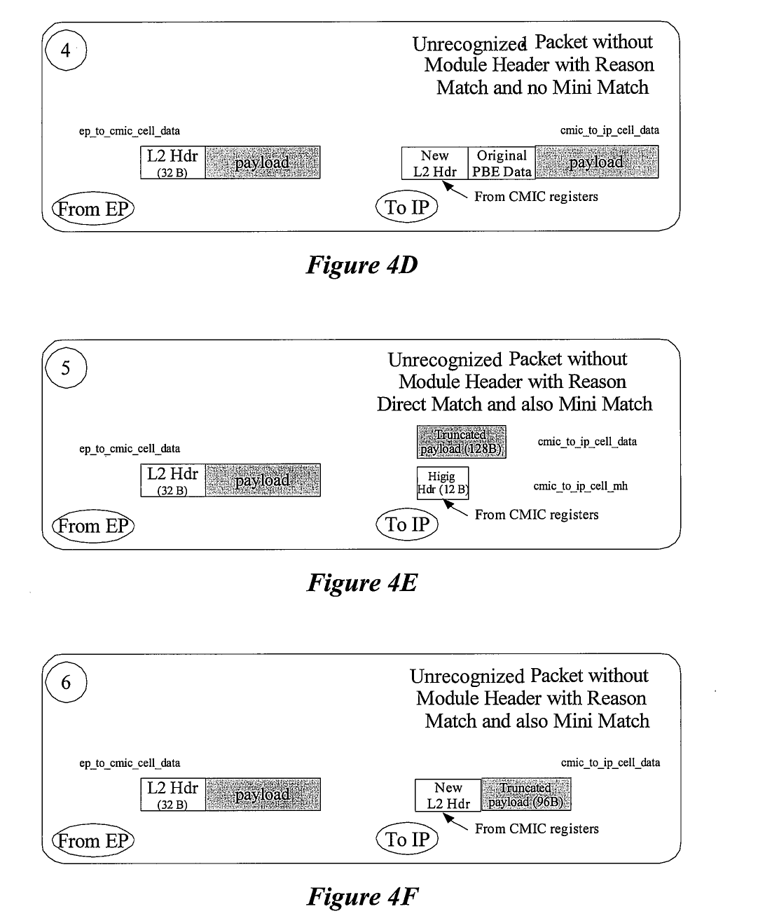

FIG. 4A is an illustration of a first exemplary remote packet processing operation for configuring an Ethernet Switch in accordance with a representative embodiment of the present invention. FIG. 4A illustrates a subtraction of 64 bytes. The CMIC starts writing the EP data for the second MOP EP cell at sub-cell #0.

FIG. 4B is an illustration of a second exemplary remote packet processing operation for configuring an Ethernet Switch in accordance with a representative embodiment of the present invention. FIG. 4B illustrates a subtraction of 32 bytes. The CMIC starts writing the EP data at sub-cell #0 for the first MOP EP cell, and this sub-cell is not overwritten later.

FIG. 4C is an illustration of a third exemplary remote packet processing operation for configuring an Ethernet Switch in accordance with a representative embodiment of the present invention. FIG. 4C illustrates a subtraction of 32 bytes. CMIC starts writing the EP data at sub-cell #0 for the first MOP EP cell and skips the first sub-cell.

FIG. 4D is an illustration of a fourth exemplary remote packet processing operation for configuring an Ethernet Switch in accordance with a representative embodiment of the present invention. FIG. 4D illustrates an addition of 32 bytes. The first 32 bytes are replaced. The CMIC starts writing the EP data at sub-cell #0 (first sub-cell) for the SOP EP cell. Sub-cell #0 of the current write buffer is overwritten from the CMIC registers during the write of sub-cell #2. Sub-cell #1 is written with the PBE field data.

FIG. 4E is an illustration of a fifth exemplary remote packet processing operation for configuring an Ethernet Switch in accordance with a representative embodiment of the present invention. FIG. 4E illustrates a subtraction of 32 bytes with truncation. The CMIC starts writing the EP data for the first MOP EP cell at sub-cell #0. While transmitting, only one buffer is transferred. The remainder of the packet is purged.

FIG. 4F is an illustration of a sixth exemplary remote packet processing operation for configuring an Ethernet Switch in accordance with a representative embodiment of the present invention. FIG. 4F illustrates a replacement of the first 32 bytes. The CMIC starts writing the EP data at sub-cell #0 (first sub-cell) for the SOP EP cell. Sub-cell #0 of the current write buffer is overwritten from the CMIC registers during the write of sub-cell #1.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for Ethernet configuration, wherein the system comprises:
an Ethernet Switch for receiving a data packet, wherein the data packet is transported over an Ethernet network by a remote processor, and wherein the data packet configures a register in the Ethernet Switch.

2. The system of claim 1, wherein the register is a CPU Management Interface Controller register.

3. The system of claim 1, wherein the Ethernet Switch comprises a direct memory access engine to process the data packet.

4. The system of claim 1, wherein the data packet controls the access of a look-up table on the Ethernet Switch.

5. The system of claim 4, wherein the contents of the look-up table are sent to the remote processor in another data packet.

6. A method for Ethernet configuration, wherein the method comprises:
receiving a data packet at an Ethernet Switch;
determining that the data packet is a remote processor packet;
accessing a Sideband Channel in the Ethernet Switch; and
transporting information associated with the data packet on the Sideband Channel.

7. The method of claim 6, wherein the method comprises:
changing a register in the Ethernet Switch according to the data packet.

8. The method of claim 6, wherein the method comprises:
reading a register in the Ethernet Switch according to the data packet, wherein the register is communicatively coupled to the Sideband Channel.

9. The method of claim 8, wherein the method comprises:
forming a responsive data packet, wherein the responsive data packet comprises a value read from the register.

10. The method of claim 6, wherein the remote processor packet is transmitted by another Ethernet Switch.

11. The method of claim 6, wherein the remote processor packet is transmitted by a remote CPU.

12. The method of claim 6, wherein the Ethernet Switch comprises a direct memory access engine to process the data packet.

13. A machine-readable storage, having stored thereon a computer program having at least one code section for configuring an Ethernet Switch, the at least one code section executable by a machine for causing the machine to perform the steps comprising:
receiving a data packet at an Ethernet Switch;
determining that the data packet is a remote processor packet;
accessing a Sideband Channel in the Ethernet Switch; and
transporting information associated with the data packet on the Sideband Channel.

14. The machine-readable storage according to claim 13, comprising code for changing a register in the Ethernet Switch according to the data packet, wherein the register is communicatively coupled to the Sideband Channel.

15. The machine-readable storage according to claim 14, wherein the register is a CPU Management Interface Controller register.

16. The machine-readable storage according to claim 13, comprising code for reading a register in the Ethernet Switch according to the data packet, wherein the register is communicatively coupled to the Sideband Channel.

17. The machine-readable storage according to claim 16, wherein the register is a CPU Management Interface Controller register.

18. The machine-readable storage according to claim 16, comprising code for forming a responsive data packet, wherein the responsive data packet comprises a value read from the register.

19. The machine-readable storage according to claim 13, wherein the remote processor packet is transmitted by another Ethernet Switch.

20. The machine-readable storage according to claim 13, wherein the remote processor packet is transmitted by a remote CPU.

21. The machine-readable storage according to claim 13, wherein the Ethernet Switch comprises a direct memory access engine to process the data packet.

22. A system for Ethernet configuration, wherein the system comprises:
a processor for generating a data packet, wherein the processor is external to an Ethernet Switch; and
wherein the data packet is transported over an Ethernet network to the Ethernet Switch, and wherein the data packet configures a register in the Ethernet Switch.

23. The system of claim 22, wherein the processor is another Ethernet Switch.

24. The system of claim 22, wherein the processor is a remote CPU.

25. The system of claim 22, wherein the register is a CPU Management Interface Controller register.
